(19) United States
(12) Patent Application Publication
(10) Pub. No.: US 2012/0163523 A1
(43) Pub. Date: Jun. 28, 2012

(54) SYNCHRONIZATION METHODS FOR DOWNHOLE COMMUNICATION

(75) Inventor: Caimu Tang, Sugar Land, TX (US)

(73) Assignee: SMITH INTERNATIONAL, INC., Houston, TX (US)

(21) Appl. No.: 12/975,553

(22) Filed: Dec. 22, 2010

(51) Int. Cl. H04L 7/04

(52) U.S. Cl. 375/362

(57) ABSTRACT

A method for synchronizing a waveform received in a subterranean borehole with a transmitted waveform includes at least one of a phase synchronization, a symbol synchronization, or a frame synchronization method. The phase and symbol synchronization methods make use of distinct loop filters which process corresponding feedback signals so as to output phase clock and symbol clock adjustments. Frame synchronization methods accumulate a preamble correlation on a symbol stream having at least one repeating preamble.

### RELATED APPLICATIONS

None.

### FIELD OF THE INVENTION

The present invention relates generally to synchronization methods for use in low frequency downhole communications, particularly, that are suitable for both uni-directional and half-duplex communications without feedback.

### BACKGROUND OF THE INVENTION

Typical petroleum drilling operations employ a number of techniques to gather information about the borehole and the formations through which it is drilled. Such techniques are commonly referred to in the art as measurement while drilling (MWD) and logging while drilling (LWD). As used in the art, there is not always a clear distinction between the terms LWD and MWD. Generally speaking MWD typically refers to measurements taken for the purpose of drilling the well (e.g., navigation and caliper) and often includes information about the size, shape, and direction of the borehole. LWD typically refers to measurements taken for the purpose of analysis of the formation and surrounding borehole conditions and often includes various formation properties, such as acoustic velocity, density, and resistivity. It will be understood that the present invention is relevant to both MWD and LWD operations. As such they will be referred to collectively herein as “MLWD.”

In many subterranean drilling operations, MLWD measurements are preferably made as close to the drill bit as possible, for example, within a few feet of the drill bit. These measurements are commonly transmitted from a near-bit sub to an upper portion of the bottom hole assembly (BHA) (i.e., above the drilling motor and/or steering tool) using an electromagnetic “short-hop” downhole communication channel. U.S. Pat. No. 5,160,925 to Dailey et al discloses one apparatus for making very low radio frequency (VLRF) electromagnetic communications in a borehole. Short-hop electromagnetic communications, such as those disclosed in the '925 patent, commonly utilized first and second, lower and upper transceivers deployed in corresponding lower and upper transceiver modules (referred to herein as LXM and UXM). Transmission from the LXM to the UXM is referred to herein as an uplink while transmission from the UXM to the LXM is referred to as a downlink.

Short hop electromagnetic communication data channels are known to be highly asymmetric. Such asymmetry is due at least in part to form factor constraints and severe channel noise at the LXM owing to its close proximity to the drill bit. This asymmetry commonly results in downlink communications being slower and less reliable than uplink communications. In certain high noise drilling environments, downlink communication can become very slow and intermittent or even virtually impossible. Prior art short hop communications techniques generally require bi-directional feedback between the LXM and the UXM. One significant drawback of this requirement is that the entire data channel (uplink and downlink) can be constrained by the aforementioned asymmetry (i.e., a slowdown or loss of downlink communications results in a corresponding slowdown or loss of uplink communications). This can be particularly problematic, for example, in geosteering and payzone steering operations in which near-bit MLWD measurements are utilized to make substantially real-time steering decisions while drilling.

There is a need in the art for a robust, multi-level synchronization scheme that enables downhole short hop electromagnetic communication without the need for any feedback between the LXM and UXM. Prior art synchronization methods are generally inadequate for downhole operations for a number of reasons. For example, these methods generally require a large number of symbols (a large data volume) for convergence and therefore have unacceptably high latency at the low frequencies used in a downhole VLRF channel. Moreover, these methods tend to be highly sensitive to noise, e.g., as is commonly encountered downhole, and are therefore prone to synchronization loss and error. There is a need in the downhole arts for synchronization methods that converge quickly and that can tolerate a highly noisy data channel without excessive loss of synchronization.

### SUMMARY OF THE INVENTION

The present invention addresses the above-described need for improved synchronization methods for downhole communications. Aspects of this invention include methods for phase synchronization, symbol synchronization, and frame synchronization of a received waveform. The phase and symbol synchronization methods make use of distinct loop filters which process corresponding feedback signals so as to output phase clock and symbol clock adjustments. Frame synchronization methods accumulate a preamble correlation on a symbol stream having at least one repeating preamble. Embodiments of the invention may make use of any one or more (including all three) of the phase, symbol, and frame synchronization methods.

Exemplary embodiments of the present invention may advantageously provide several technical advantages. For example, exemplary phase, symbol, and frame synchronization methods according to this invention tend to provide both rapid and accurate convergence. These methods also tend to be insensitive to white noise.

Moreover, phase, symbol, and frame synchronization methods in accordance with the invention may therefore be advantageously utilized in either uni-directional (contiguous) communications or half-duplex communications without the need for feedback. The inventive methods may also be utilized in half-duplex communications that make use of time division on channel accesses. By eliminating the need for feedback, the inventive methods also enable a rapid resynchronization in the event of a synchronization loss (e.g., due to a burst of noise). Eliminating the need for feedback also tends to significantly increase the uplink communication speed (e.g., by an order of magnitude or more). These and other advantages are described in more detail below with respect to various embodiments of the invention.

In one aspect the present invention includes a method for synchronizing a received waveform with respect to a transmitted waveform. A waveform is received in a subterranean borehole and pre-processed to obtain in-phase and out-of-phase digitized waveforms. The in-phase and out-of-phase digitized waveforms are processed to obtain at least one phase adjustment and a symbol clock adjustment which are in turn further processed to obtain a decoded symbol sequence. The decoded symbol sequence is then processed to obtain a frame boundary.

In another aspect the present invention includes a method for synchronizing a received waveform with respect to a starting phase of a transmitted waveform. A waveform is received in a subterranean borehole and pre-processed to obtain in-phase and out-of-phase digitized waveforms. The in-phase and out-of-phase digitized waveforms are processed in combination with one another to obtain a feedback signal which is in turn further processed using a loop filter to obtain a phase adjustment.

In still another aspect, the present invention includes a method for synchronizing a received waveform with respect to a symbol transition in a transmitted waveform. A waveform is received in a subterranean borehole and pre-processed to obtain in-phase and out-of-phase digitized waveforms. At least one of the in-phase and out-of-phase digitized waveforms is processed to obtain a feedback signal which is in turn processed using a loop filter to obtain a symbol clock adjustment.

In yet another aspect, the present invention includes a method for synchronizing a received symbol sequence with respect to a frame boundary in a transmitted waveform. A decoded symbol sequence is received at a downhole processor. The symbol sequence includes a plurality of frames and at least one repeating preamble sequence, each of the frames including a preamble sequence and a corresponding payload. Each preamble sequence includes a plurality of decoded symbols. A correlation of each preamble sequence in the decoded symbol sequence is computed to obtain a frame boundary. The decoded symbol sequence and the frame boundary are then processed to decode the payload symbols.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a conventional drilling rig on which exemplary method embodiments of the present invention may be utilized.

FIG. 2 depicts an exemplary BHA configuration on which method embodiments of the present invention may be utilized.

FIG. 3 depicts a flowchart of one exemplary method embodiment in accordance with the present invention including phase, symbol, and frame synchronization steps.

FIG. 4 depicts a flowchart of one exemplary method embodiment for phase synchronization in accordance with the present invention.

FIG. 5 depicts a QPSK phase loop filter scheme in accordance with the present invention.

FIG. 6 depicts a flowchart of one exemplary method embodiment for symbol synchronization in accordance with the present invention.

FIG. 7 depicts a flow chart of a preferred portion of the method depicted on FIG. 6.

FIG. 8 depicts a schematic I channel symbol transition in an exemplary symbol loop filtering operation.

FIG. 9 depicts a flowchart of one exemplary method for frame synchronization in accordance with the present invention.

### DETAILED DESCRIPTION

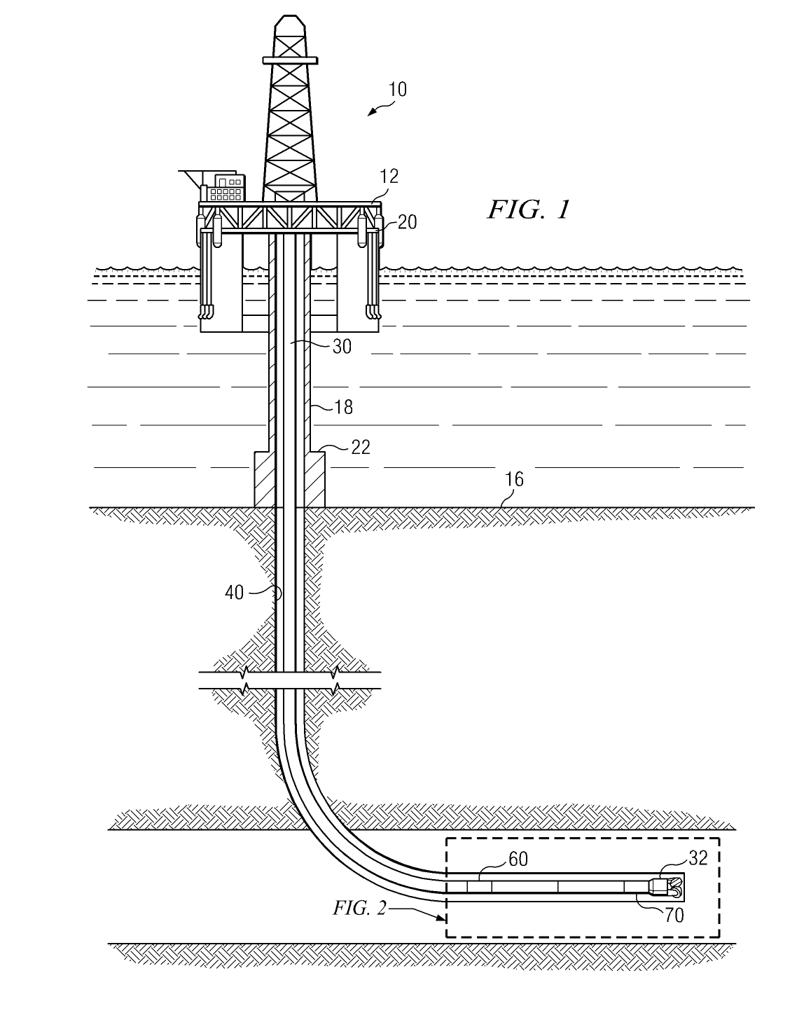

FIG. 1 depicts an exemplary offshore drilling assembly, generally denoted 10, suitable for employing exemplary method embodiments in accordance with the present invention. In FIG. 1 a semisubmersible drilling platform 12 is positioned over an oil or gas formation (not shown) disposed below the sea floor 16. A subsea conduit 18 extends from deck 20 of platform 12 to a wellhead installation 22. The platform may include a derrick and a hoisting apparatus for raising and lowering the drill string 30, which, as shown, extends into borehole 40 and includes drill bit 32, and upper and lower subs 60 and 70. Drill string 30 may optionally further include substantially any number of other tools including, for example, other MLWD tools, stabilizers, a rotary steerable tool, and a downhole drilling motor.

It will be understood by those of ordinary skill in the art that the deployment illustrated on FIG. 1 is merely exemplary. It will be further understood that exemplary embodiments in accordance with the present invention are not limited to use with a semisubmersible platform 12 as illustrated on FIG. 1. The invention is equally well suited for use with any kind of subterranean drilling operation, either offshore or onshore.

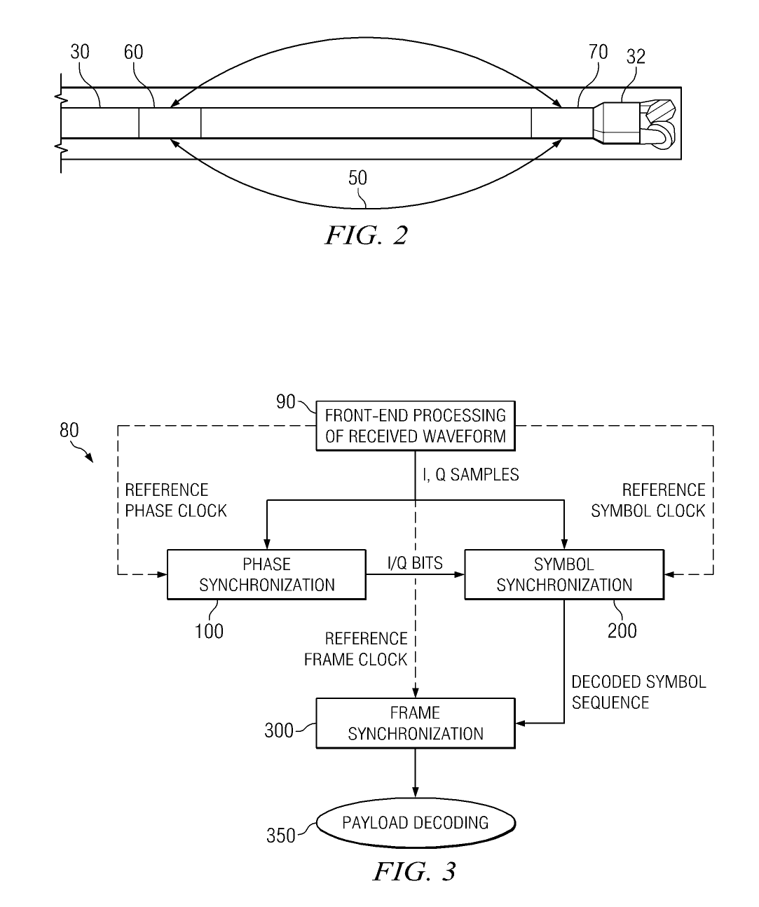

Referring now to FIG. 2, a bottom hole assembly (BHA) portion of drill string 30 is depicted in further detail. As described above, the BHA includes upper and lower subs 60 and 70. In the exemplary embodiment shown these subs are configured to provide a short hop communication channel through the external formation (as depicted at 50), for example, via a very low radio frequency (VLRF) electromagnetic carrier (e.g., having a frequency of less than about 10 kHz). Each of the upper and lower subs 60 and 70 (UXM and LXM) includes a conventional transceiver (e.g., a geometrically limited coil deployed substantially coaxially with the drill string). In a typically drilling operation, MLWD data (e.g., inclination and gamma ray counts) may be uplinked from LXM 70 to UXM 60. Various instructions and/or commands may be downlinked from the UXM 60 to LXM 70. It will be understood that the invention is not limited to the transmission and/or reception of any particular data, instructions, and/or commands. Nor is the invention limited to any particular communication direction (e.g., uplink versus downlink) or to any transceiver communication or communication channel.

As described above in the Background Section, prior art short hop communications techniques generally require bi-directional feedback between the LXM and the UXM. One significant drawback of this requirement is that the entire data channel (both uplink and downlink) is constrained by any asymmetry in the communications channel. As a result of the asymmetry inherent in downhole short hop communication systems (particularly near bit systems), a slowdown or loss of communications in one direction (commonly the downlink) results in a corresponding slowdown or loss communications in the other direction. The present invention is intended to overcome this problem by providing rapid and robust synchronization methods that enable uni-directional communication (e.g., uplink only). Received data may be synchronized with a transmitted data signal at one or more levels including, for example, phase synchronization, symbol synchronization, and frame synchronization without the need for any feedback.

FIG. 3 depicts one exemplary method embodiment 80 in accordance with the present invention in which a received waveform is synchronized with respect to (i) the starting phase of a transmitted waveform, (ii) the starting point of a symbol period in the transmitted waveform, and (iii) the starting point of a data frame that includes both preamble and payload symbols. It will be understood that the invention is not limited to embodiments including each of the aforementioned synchronization steps. Rather, embodiments in accordance with the present invention may include any one (or any combination) of these synchronization steps.

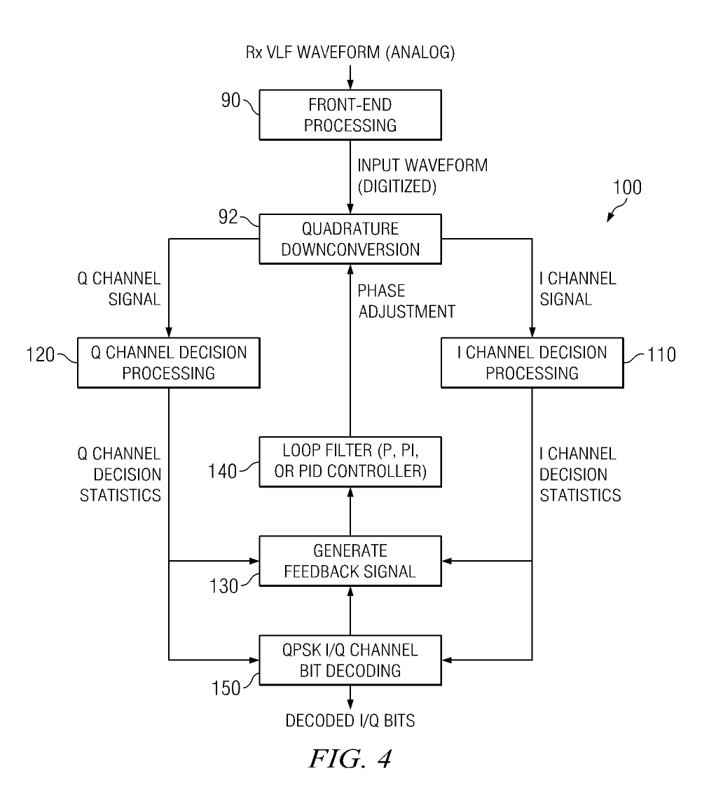

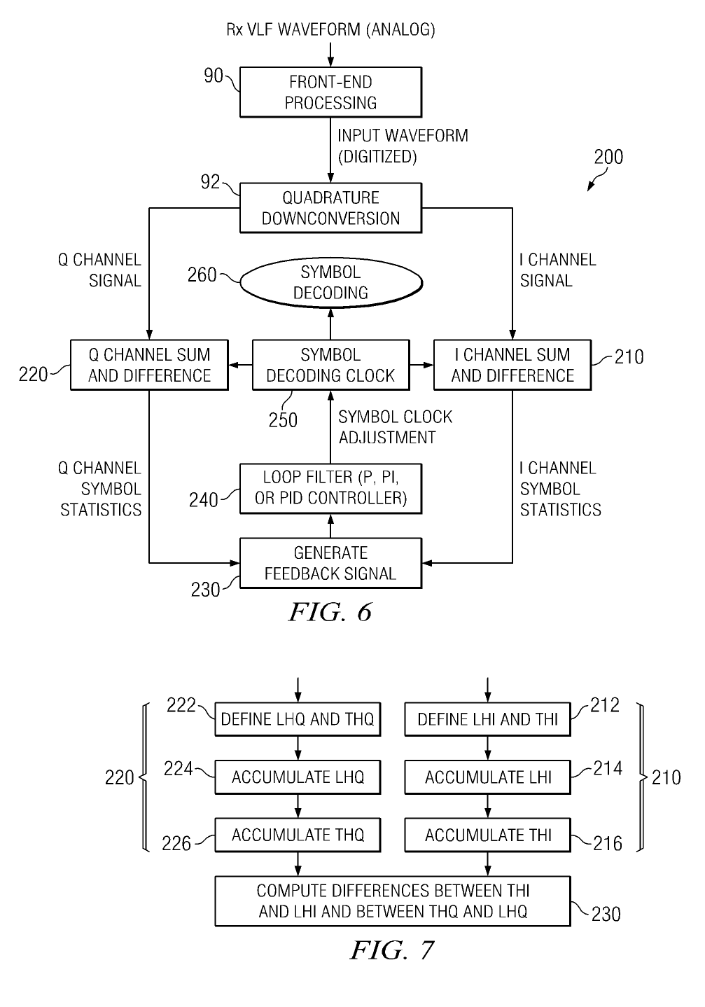

The received waveform is pre-processed at 90 prior to synchronization. The pre-processing commonly includes, for example, known filtering, amplification, analog to digital conversion, and quadrature downconversion steps. In the exemplary embodiment depicted the quadrature downconversion step (shown at 92 in FIGS. 4 and 6) outputs distinct in-phase and out-of-phase I and Q channel waveforms. These waveforms are received and utilized in both the phase synchronization 100 and the symbol synchronization 200 processes. The phase synchronization process 100 outputs at least one phase point (phase adjustment) while the symbol synchronization process 200 outputs a symbol clock adjustment. The phase and symbol clock adjustments are used in symbol decoding as described in more detail below. In the exemplary embodiment depicted the symbol synchronization process 200 outputs a decoded symbol sequence to the frame synchronization process 300. The frame synchronization process tags the frame starting point (the frame boundary), which enables the payload symbols to be decoded at 350. Reference clocks are further received and utilized by the phase synchronization 100, symbol synchronization 200, and frame synchronization 300 processes as depicted.

Preferred embodiments of the phase synchronization 100, symbol synchronization 200, and frame synchronization 300 steps are described in more detail below in PHASE SYNCHRONIZATION, SYMBOL SYNCHRONIZATION, and FRAME SYNCHRONIZATION.

### Phase Synchronization

FIG. 4 depicts a flow chart of one exemplary phase synchronization method embodiment 100 in accordance with the present invention. Method 100 is a method for phase synchronizing (also referred to as phase locking) a received waveform with respect to a transmitted waveform. A transmitted waveform may be received and pre-processed at 90, for example, as described above with respect to FIG. 3. Such pre-processing may include, for example, known anti-aliasing filtering, amplification, and analog to digital conversion steps. The digitized waveform may then be expressed mathematically, for example, as follows:

x(t)=d₁ sin Φ(t)+d₂ cos Φ(t) Equation 1

where x(t) represents the digitized waveform, d₁, d₂ ∈ {1, −1} represent the input data bits, and Φ(t) represents the carrier phase in the general form ωt+θ, where ω represents the carrier frequency in radians per second and θ represents the initial phase at the transmitter.

The digitized waveform undergoes a quadrature downconversion at 92 to generate I and Q (in-phase and out-of-phase) digitized waveforms. Quadrature downconversion to zero frequency (i.e., DC) is preferred in that it significantly simplifies subsequent processing. Those of ordinary skill in the art will readily appreciate that the information encoded in x(t) is fully preserved in the DC components of the I and Q channels.

With continued reference to FIG. 4, the I and Q channels are processed at 110 and 120 to generate corresponding I and Q channel decision statistics which are in turn further processed in combination at 130 to generate a feedback signal. The feedback signal is input into a loop filter (e.g., a proportional (P), proportional integral (PI), or proportional integral differential (PID) controller) at 140 to obtain a phase adjustment. The phase adjustment is received as an input into the aforementioned quadrature downconversion step at 92. The I and Q channel decision statistics are further decoded at 150 to obtain, for example, the QPSK I and Q channel bits. The decoded I and Q channel bits may be further utilized in a symbol decoding step to obtain a decoded symbol as described in more detail below in SYMBOL SYNCHRONIZATION.

When used with a QPSK modulation scheme, phase synchronization method 100 may be configured to converge to one out of four possible phase points in the range 0≦θ<2π. The four possible phase points θ₁, θ₂, θ₃, and θ₄ may be evenly spaced at intervals of π/2 radians such that the phase points may be related to one another mathematically, for example, as follows: θ₄=θ₃+π/2=θ₂+π=θ₁+3π/2. As described in more detail below, decoded symbols may be obtained for each of the four phase points. This apparent phase ambiguity is addressed below in the FRAME SYNCHRONIZATION section of this disclosure. While the exemplary method embodiments are described herein with respect to QPSK encoding, it will be understood that the invention is not so limited. Certain embodiments of the invention are suitable for other encoding schemes such as frequency shift keying (FSK) or quadrature amplitude modulation (QAM). It will also be understood that embodiments of the invention may be extended in a straightforward way for utilization with other N-phase shift keying modulation (e.g., N=8, 16, etc).

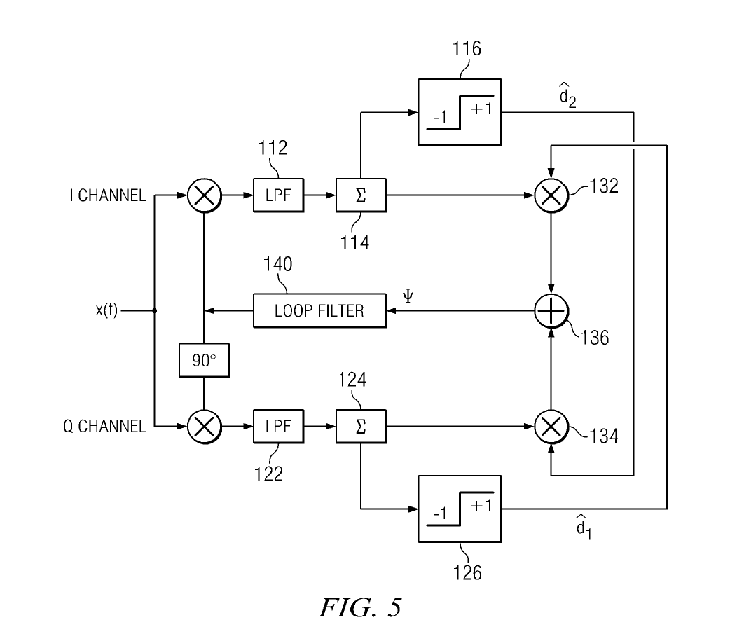

One exemplary embodiment of method 100 is now described in further detain with respect to FIG. 5. The outputs of the I and Q channels after quadrature downconversion, ε_{I} and ε_{Q}, may be expressed mathematically, for example, as follows:

ε_{I}=(\hat{d}₁ sin Φ(t)+\hat{d}₂ cos Φ(t))cos \hat{Φ}

ε_{Q}=−(\hat{d}₁ sin Φ(t)+\hat{d}₂ cos Φ(t))sin \hat{Φ} Equation 2

where \hat{d}₁ and \hat{d}₂ represent the first and second input bits of the input symbol, Φ(t) is as defined above, and \hat{Φ} represents the estimated phase at the receiver where φ=Φ−\hat{Φ} represents the estimated phase error residual which forms the feedback signal in the loop filter.

In the exemplary embodiment depicted, ε_{I} and ε_{Q} may be numerically low-pass filtered at 112 and 122, for example, using a cut-off frequency of 2ω so as to remove harmonic oscillations of the carrier frequency (i.e., first order and higher). The filtered outputs may be represented mathematically, for example, as follows:

ε_{I}=\hat{d}₁ cos φ+\hat{d}₂ sin φ

ε_{Q}=\hat{d}₁ sin φ−\hat{d}₂ cos φ Equation 3

where ε_{I}, ε_{Q}, \hat{d}₁, \hat{d}₂, and φ are as defined above.

With continued reference to FIG. 5, demodulated sums of the filtered output samples may be computed over some predetermined period (e.g., over a single phase cycle) at 114 and 124. In the exemplary embodiment depicted, these demodulated sums and their corresponding signs (positive or negative) which may be determined at 116 and 126 represent the decision statistics output from the I and Q channel processing 110 and 120 depicted on FIG. 4. These decision statistics may be processed, for example, by cross multiplying the I and Q channel decision statistics to obtain a feedback signal. As depicted on FIG. 5, by cross multiplying it is meant that the output value of the I channel summation obtained at 114 may be multiplied at 132 by the sign of the Q channel summation obtained at 126. Likewise, the output value of the Q channel summation obtained at 124 may be multiplied at 134 by the sign of the I channel summation obtained at 116. The products obtained at 132 and 134 may then be summed at 136 to obtain the feedback signal. The feedback signal Ψ(t) is generally a piece-wise function and may be represented mathematically, for example, as follows:

Ψ(t)=\hat{d}₂² ε_{I}+\hat{d}₁² ε_{Q}=2 sin φ Equation 4

where ε_{I}, ε_{Q}, \hat{d}₁, \hat{d}₂, and φ are as defined above and where \hat{d}₂²+\hat{d}₁²=2 after an appropriate normalization of Ψ(t) . Those of ordinary skill in the art will readily appreciate that a simple negative linear feedback system can be created using Ψ(t) since sin φ is essentially linearly related to φ when φ approaches zero (i e., since

$${lim}_{φ -> 0} \frac{sin φ}{φ} = 1 ) .$$

It will be understood that the invention is not limited to embodiments utilizing the particular feedback signal described above with respect to Equation 4. In one alternative embodiment a difference of the sums computed in 114 and 124 yields a feedback signal having the following mathematical form:

Ψ(t)=\hat{d}₂² ε_{Q}−\hat{d}₁² ε_{I}=2 cos φ Equation 5

It will be appreciated that a feedback signal of 2−Ψ(t)=2(1−cos φ) will tend to converge since

$${lim}_{φ -> 0} \frac{2 - 2 cos φ}{{φ}^{2}} = 1$$

(i.e., when Ψ(t) approaches 1, φ² approaches zero).

Those of ordinary skill in the art will appreciate that the feedback signal (e.g., as computed in Equation 4) may be filtered (e.g., using a finite impulse response or an infinite impulse response filter) prior to executing the loop filter at 140. The invention is not limited in these regards.

Phase loop filter 140 is configured for use with a waveform (e.g., a QPSK waveform) having a random sequence of symbols. In the exemplary embodiments depicted, the phase loop filter 140 is configured to iteratively adjust (update) the phase at some predetermined filter update interval. These phase adjustments (the outputs from the loop filter) may be input into the quadrature downconversion 92 as depicted on FIGS. 4 and 5. It will be understood that substantially any suitable update interval (represented mathematically herein as δ) may be utilized. Shorter intervals tend to result in a more rapid convergence and phase lock, while longer intervals tend to result in a slower but more accurate convergence and phase lock.

In one preferred embodiment of the invention, a two-stage loop filter is utilized. In the first stage (referred to as the phase locking stage), a short update interval is utilized to promote a rapid convergence. The short update interval may be, for example, approximately equal to the number of digital samples in a single phase cycle (e.g., M=100 samples). In the second stage (referred to as the phase tracking stage), a longer update interval is utilized to promote accuracy. The longer update interval may be, for example, approximately equal to the number of digital samples in a symbol period (i.e. sM samples where s represents the number of phase cycles per symbol and M represents the number of digital samples per phase cycle, e.g., 2000 samples when s=20 and M=100). It will be understood that the invention is not limited to an update interval having any particular number of samples. Nor is the invention limited to an update interval having an integer multiple of the number of samples per phase cycle.

Since the digitized waveform commonly includes one or more symbol transitions, the loop filter is preferably not memoryless (i.e., prior values of the feedback signal are preferably incorporated into the computation of the phase adjustment). One exemplary zeroth order loop filter that incorporates prior values of the feedback signal may be represented mathematically, for example, as follows:

$$NCO = NCO + sign ( {\sum }_{0 \leq i < H} Ψ ( t - i δ ) ) η \qquad Equation 6$$

where NCO represents the numerically controlled oscillator (which is related to the phase adjustment), Ψ represents the feedback signal, δ represents the update interval, η represents the magnitude of the gain factor, and H represents the number of intervals in memory. As described in Equation 6, the phase adjustment is calculated based on an aggregate of a fixed number of prior feedbacks (intervals), with each adjustment being fixed to a desired level of granularity based on selected values of η and H. Those of skill in the signal processing arts will appreciate that the loop filter described by Equation 6 is a proportional controller when H equals 1 and a proportional integral controller having a simplified gain control when H is greater than 1.

One exemplary first order (linear) filter that incorporates prior values of the feedback signal may be represented mathematically, for example, as follows:

NCO=λ₁Γ_{P}+λ₂Λ_{P} Equation 7

where NCO again represents the numerically controlled oscillator (which is related to the phase adjustment), Γ_{P} and Λ_{P} represent the phase loop integral magnitude and proportional magnitude for the PI controller, and λ₁ and λ₂ represent gain factors for the phase loop integral and proportional controllers. In one exemplary embodiment, the phase loop integral magnitude Γ_{P} may be determined via a summation operation while the phase loop proportional magnitude Λ_{P} may be equal to the feedback signal at any particular time such that Γ_{P} and Λ_{P} may be expressed mathematically, for example, as follows:

$${Γ}_{P} = ( {\sum }_{0 < i < {H}_{0}} Ψ ( t - i δ ) ) \\ {Λ}_{P} = Ψ ( t ) \qquad Equation 8$$

where H₀ represents the total number of phase loop-filter iterations since the start of the start of the phase synchronization process (e.g., since the initial start up or since the most recent loss of synchronization).

The loop filter models described above with respect to Equations 6 and 7 advantageously tend to be robust even when the loop filter update interval is changed (e.g., from a phase locking to a phase tracking stage) so long as the feedback signals {Ψ(t)|t=δ, 2δ, 3δ . . . } are properly normalized. It has been observed that the first order model generally converges faster than the zeroth-order model; however, the zeroth-order model tends to be simpler to adjust and is less computationally intensive (which can be advantageous in downhole operations).

The feedback signal Ψ(t) described above tends to be both robust and highly sensitive to phase errors. Therefore, phase synchronization methods in accordance with the present invention tend to advantageously converge quickly. The feedback signal also tends to be insensitive to white noise (those of ordinary skill in the art will readily appreciate that white noise sums to zero at 114 and 124). Being insensitive to white noise, the feedback signal also tends to be insensitive to interruption of the transmitted signal, e.g., during half duplex communications employing time division. Phase synchronization methods in accordance with the invention may therefore be advantageously utilized in either uni-directional (contiguous) communications or half-duplex communications that make use of time division. The invention is not limited in these regards.

### Symbol Synchronization

Symbol synchronization methods in accordance with the present invention may be utilized in combination with or independent of the above described a phase synchronization methods. As a result, symbol synchronization may be performed essentially in parallel with phase synchronization (i.e., such that the phase and symbol synchronizations are initiated at substantially the same time).

FIG. 6 depicts one exemplary embodiment of a symbol synchronization method 200 in accordance with the present invention. Method 200 is configured to synchronize a received waveform with respect to a symbol transition in a transmitted waveform. The transmitted waveform may be received and pre-processed at 90. As described above with respect to FIG. 3, such pre-processing may include, for example, anti-aliasing filtering, amplification, and analog to digital conversion. As also described above with respect to FIGS. 3, 4, and 5, the digitized waveform undergoes a quadrature downconversion at 92 to generate distinct I and Q channel (in-phase and out-of-phase) digitized waveforms.

Symbol synchronization method 200 is similar to phase synchronization method 100 in that it generates a feedback signal that is input into a loop filter (symbol loop filter 240). Each of the I and Q channels receives a continuous data stream from the quadrature downconversion at 92. A predetermined snapshot of data in each channel (e.g., a single symbol period including sM samples) may be processed at 210 and 220, for example, to determine I channel and Q channel symbol statistics (e.g., a sum or weighted average). These symbol statistics may be further processed at 230 to generate a feedback signal. The feed back signal is input into a loop filter (e.g., a proportional (P), proportional integral (PI), or proportional integral differential (PID) controller as described above with respect to FIG. 4) to obtain a symbol clock adjustment at 240. A symbol decoding clock executes the symbol clock adjustment at 250, for example, by adjusting the symbol starting point by an integer number of cycles. The decoding clock may further retain and accumulate residuals (fractional cycles) for later intervals. The method then returns to the I and Q channel processing at 210 and 220. The output from the symbol decoding clock may also be input into a symbol decoding block 260. The symbol decoding may also make use of the I and Q channel bits determined, for example, at step 150 of FIG. 4.

FIG. 7 depicts a flowchart of a preferred embodiment of the I channel and Q channel processing depicted on FIG. 6. At 212 a leading half (LHI) and a trailing half (THI) of the I channel snapshot is defined. At 222 a leading half (QHI) and a trailing half (QHI) of the Q channel snapshot is defined. It will be understood that these “halves” are not necessarily precise halves and that substantially any suitable portions may be defined. For example, a leading third and trailing two-thirds of the snapshot may be substantially equivalently defined at 212 and 222. However, LHI and LHQ preferably include the same number of samples (as do THI and THQ).

In a preferred embodiment in which the snapshot equals the symbol length (i.e., when there are sM samples in the snapshot), the following invariants hold: (i) at least one of LHI and THI does not include a symbol transition and (ii) at least one of LHQ and THQ does not include a symbol transition. Moreover, in the event of a type D symbol transition (a transition from one symbol to a different symbol), at least one of LHI, LHQ, THI, and THQ includes a phase transition representative of the symbol transition (which is representative of the starting point of the symbol).

With continued reference to FIG. 7, demodulated sums of each of LHI and THI are computed at 214 and 216. Demodulate sums of each of LHQ and THQ are also accumulated at 224 and 226. Those of ordinary skill in the art will understand that in the absence of a symbol transition (and in the further absence of noise and phase error), the demodulated sums computed at 214, 216, 224, and 226 are approximately equal to the number of phase cycles in the summed portion. For example, a sum of 10 is expected for an LHI including 10 phase cycles having no symbol transitions.

One aspect of the present invention is the realization that the demodulated sums computed in 214, 216, 224, and 226 are also indicative of the location of a symbol transition (a TD transition). In the absence of noise and phase error (e.g., due to incomplete phase synchronization), each phase cycle located before the transition sums to approximately 1 and each phase cycle located after the transition sums to approximately negative 1. For example a demodulated sum of approximately −4 is expected for an LHI including 10 phase cycles and having a symbol transition located between the third and fourth phase cycles (3−7=−4).

A suitable feedback signal may be obtained at 230 (FIGS. 6 and 7), for example, by computing differences between the above described trailing half and leading half demodulated sums. These differences are typically computed for both the I and Q channels (either or both of which may be used for the feedback signal). It is well known that in QPSK processing a symbol transition may be indicated by a phase transition in either or both of the I and Q channels. When the symbol transition includes an I channel transition (but no Q channel transition), the I channel difference may be utilized as the feedback signal. When the symbol transition includes a Q channel transition (but no I channel transition), the Q channel difference may be utilized as the feedback signal. When the symbol transition includes both I and Q channel transitions, either of the I or Q channel differences may be utilized as the feedback signal. Alternatively, an average (or weighted average) may be utilized as the feedback signal. It will also be understood that the invention is not limited to computing a true mathematical difference as those of ordinary skill in the art will readily be able to substitute other linear functions which are similar to a mathematical difference.

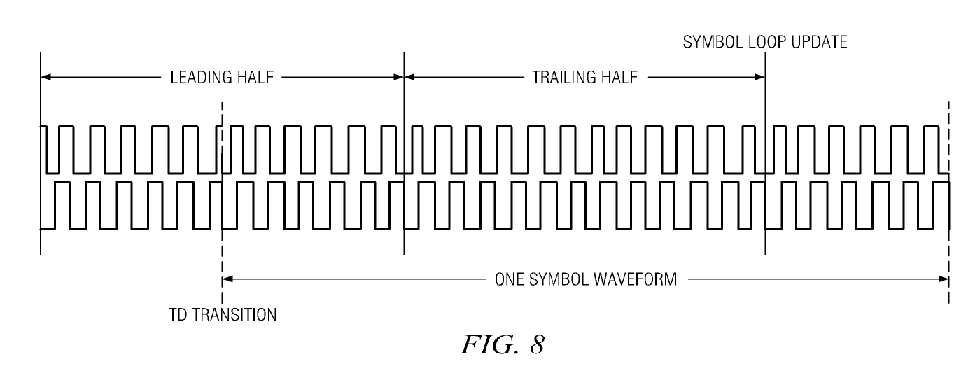

FIG. 8 depicts exemplary I channel and canonical reference (sin \hat{Φ}) waveforms for the purposes of further describing one exemplary embodiment of method 200. A square wave is used for illustrative purposes. In the exemplary embodiment depicted the symbol waveform includes 24 phase cycles, twelve of which are located in the leading half of the snapshot (LHI) and twelve of which are located in the trailing half of the snapshot (THI). The I channel includes a symbol transition at the center of the LHI (i.e., after six phase cycles). In the absence of noise and phase error, the LHI demodulated sum is equal to about zero (six phase cycles before the phase transition and six phase cycles after the transition), while the THI demodulated sum is equal to about 12. An exemplary feedback signal of half the difference between THI and LHI (i.e., (THI−LHI/2)) is equal to approximately six indicating that symbol clock need to be adjusted by six phase cycles at 250 of FIG. 6.

Those of ordinary skill in the art will appreciate that the presence of colored noise in the data channel and/or an incomplete phase synchronization can result in a feedback signal having a non-integer value. The symbol clock preferably adjusts the symbol starting point by an integer number of cycles and retains the remainder as a residual (e.g., in loop filter memory as described in more detail below) for use in future intervals.

Those of ordinary skill in the art will also appreciate that there are 12 possible types of TD transitions in QPSK processing (three types of transitions—I channel, Q channel, or I and Q channel at four distinct phase points). Provided that the symbol period is an integer multiple of phase cycles, the feedback signal described above advantageously provides a statistically identical signal for each of these possible transitions. This provides for robust symbol synchronization irrespective of the symbol transition. Convergence tends to be advantageously rapid and accurate.

While the preferred loop update interval (snapshot) is equal to the symbol length sM, it will be understood that the invention is not limited in this regard. Substantially any other loop update interval may be utilized with the understanding that (i) a lengthy update interval (e.g., greater than about 2 sM) tends to reduce convergence speed and (ii) a short interval (e.g., less than about sM/2) tends to unnecessarily increase variation in the feedback signal.

The computed feedback signal(s) are input into a symbol loop filter as depicted in FIGS. 6 and 7. Due to the presence of noise and possibly an incomplete or imperfect phase synchronization, the symbol loop filter is preferably not memoryless (i.e., a recent history of the feedback signal is preferably retained and used). One exemplary linear (first order) symbol loop filter that incorporates prior values of the feedback signal may be represented mathematically, for example, as follows:

NSC=μ₁Γ_{S}+μ₂Λ_{S} Equation 9

where NSC represents the numerically derived symbol clock (which is related to the symbol clock adjustment), Γ_{S} and Λ_{S} represent the symbol loop integral magnitude and proportional magnitude for the PI controller, and μ₁ and μ₂ represent gain factors for the symbol loop integral and proportional controllers. In one exemplary embodiment, the symbol loop integral magnitude Γ_{S} may be determined via a summation operation while the symbol loop proportional magnitude Λ_{S} may be equal to the feedback signal at any particular time such that Γ_{S} and Λ_{S} may be expressed mathematically, for example, as follows:

$${Γ}_{S} = ( {\sum }_{0 < i < {K}_{0}} Ω ( t - i sM ) ) \\ {Λ}_{P} = Ω ( t ) \qquad Equation 10$$

where Ω(t) represents the symbol feedback signal (e.g., at intervals t=sM, 2 sM, 3 sM . . . ), and K₀ represents the total number of symbol loop filter iterations since the start of the start of the symbol synchronization process (e.g., since the initial start up or since the most recent loss of synchronization).

In the exemplary embodiment described above, the feedback signal Ω(t) is derived from the leading half and trailing half of a single symbol period. It will be understood that the invention is not limited in this regard. The feedback signal may also be determined from the leading half of a first symbol period and the trailing half of a second symbol period. Moreover, in such embodiments, the first and second symbol periods need not even be consecutive.

The feedback signal Ω(t) described above tends to provide an accurate indication of the number of phase cycles by which the symbol clock is offset. Symbol synchronization methods in accordance with the present invention therefore tend to advantageously converge quickly. The feedback signal also tends to be insensitive to white noise (those of ordinary skill in the art will readily appreciate that white noise sums to zero when computing the demodulated leading half and trailing half sums). Being insensitive to white noise, the feedback signal also tends to be insensitive to interruption of the transmitted signal, e.g., during half duplex communications employing time division. Symbol synchronization methods in accordance with the invention may therefore be advantageously utilized in either uni-directional (contiguous) communications or half-duplex communications that make use of time division. The invention is not limited in these regards.

### Frame Synchronization

Frame synchronization methods in accordance with the present invention may be advantageously independent of the above described phase and symbol synchronization methods. When used in combination with phase synchronization method 100 described above with respect to FIGS. 4 and 5, frame synchronization methods in accordance with the present invention advantageously remove phase ambiguity.

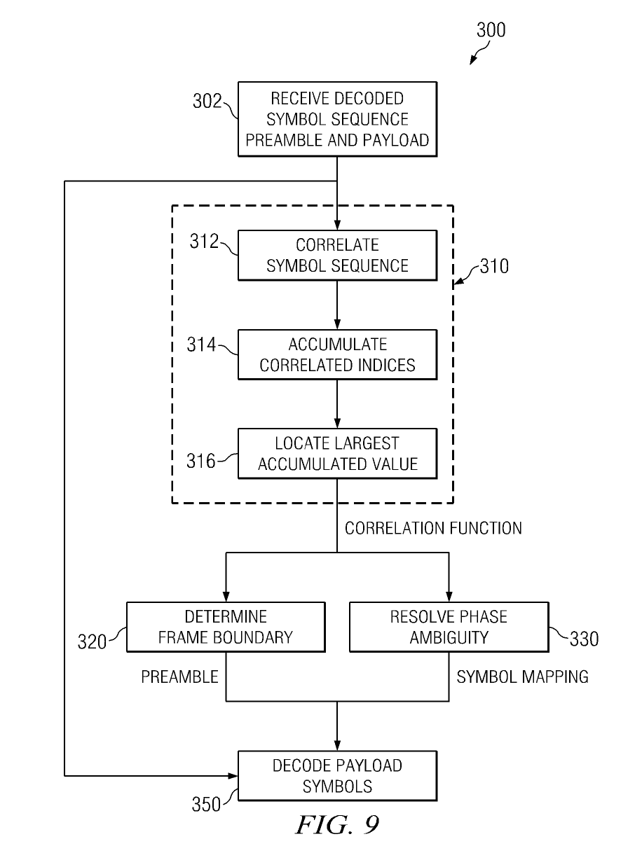

FIG. 9 depicts one exemplary embodiment of a frame synchronization method 300 in accordance with the present invention. Method 300 is configured to synchronize a decoded symbol sequence (obtained from a received waveform) with respect to a frame boundary in a transmitted waveform. A decoded symbol sequence having a repeating preamble is received at 302. The symbol sequence may be divided into a plurality of sequential frames, each of which includes a single occurrence of the preamble followed by a payload. In one exemplary embodiment of the invention, each frame may include, for example, 64 symbols; a four symbol preamble followed by a 60 symbol payload. The invention is, of course, not limited to any particular frame size. Moreover, symbol synchronization can still be established when the frame size is allowed to vary at run-time (e.g., when the transmitter selects a frame size in a predetermined range based upon the data volume).

A preamble correlation may be computed at 310 on the received symbol sequence to obtain a frame boundary. As described in more detail below, the exemplary embodiment depicted includes a correlation step at 312 in which the received symbol sequence is checked for the occurrence of the preamble. The correlation obtained at 312 may then be accumulated at 314 at a predetermined frame spacing. The accumulated correlation may be searched at 316 for the highest value. A frame boundary (or starting point) may be set at 320 to the location of the highest value found in 316. Any phase ambiguity remaining from the phase correlation step 100 (FIG. 3) may also be resolved at 330. Upon setting the frame boundary and resolving any remaining phase ambiguity, the payload symbols may be decoded and output as data bits as depicted at 350. Those of skill in the art will appreciate that the invention does not require the use of preamble emulation prevention techniques in the payload symbol sequence. The invention tends to provide robust frame synchronization even when the payload symbol sequence contains many non-correlated preamble occurrences.

In a preferred embodiment of the invention a first-in first-out (FIFO) symbol buffer B1 is defined in 312. The buffer may include, for example, twice the number of symbols as a single frame (i.e., 2K symbols where K equals the number of symbols per frame). The buffer is initially set to zero. During the frame synchronization process the algorithm checks the latest κ symbols (where κ represents the number of symbols in the frame preamble) for each of the four possible preamble symbol combinations Θ₁, Θ₂, Θ₃, and Θ₄ corresponding to the four possible phase points θ₁, θ₂, θ₃, and θ₄ described above in PHASE SYNCHRONIZATION. The algorithm returns an index corresponding to the number of matched symbols for each of Θ₁, Θ₂, Θ₃, and Θ₄, wherein the index may equal, for example, 0, 1, 2, . . . , κ. The invention is not limited to any particular indexing scheme. In another embodiment, the index equals, for example, −2κ, −2κ+2, . . . , 2κ−2, 2κ. The returned indices are saved to the corresponding position in B1.

A second FIFO buffer B2 (e.g., of the same length as B1) is defined in 314 for accumulating indices stored in B1. Initially B2 is also cleared to zero. The correlated indices are accumulated (e.g., summed) at intervals equal to the frame length and stored to the corresponding position in B2. After at least a full frame of symbols has been correlated and accumulated at 312 and 314, buffer B2 is searched for the largest accumulated value at 316 as described above. The frame boundary may be set at the symbol location of the largest value in B2 at 320. The particular phase point θ₁, θ₂, θ₃, or θ₄ may be determined at 330 based upon which of the preambles, Θ₁, Θ₂, Θ₃, or Θ₄, returns the largest accumulated value at 316.

While the exemplary embodiment is described above with respect to the use of a single preamble (i.e., repeating the same preamble frame after frame), it will be understood that the invention is not limited in this regard. Alternating preambles may also be utilized (e.g., alternating first and second preambles). Such a process may require longer buffers as well as modified indices and counters. Notwithstanding, those of ordinary skill in the art will readily be able to extend the exemplary embodiments described above to embodiments that make use of more than one preamble.

Accumulation of the correlated preambles tends to amplify the presence of the frame boundary (since the correlation is summed). Frame synchronization methods in accordance with the present invention therefore tend to advantageously converge quickly. Frame synchronization method 300 also tends to be insensitive to an interruption of the transmitted signal in the payload portion of the frame, e.g., as may occur during half duplex communications employing time division. Symbol synchronization methods in accordance with the invention may therefore be advantageously utilized in either uni-directional (contiguous) communications or half-duplex communications that make use of time division. The invention is not limited in these regards.

Those of ordinary skill in the art will appreciate that the methods described above in accordance with the present invention are configured for digital implementation. These methods are well suited for downhole applications in that, as compared to analog methods, they tend to (i) reduce real-estate requirements on printed circuit boards, (ii) reduce power consumption, (iii) improve robustness and reliability due to the use of fewer circuit components.

It will be understood that the aspects and features of the present invention may be embodied as logic that may be processed by, for example, a computer, a microprocessor, hardware, firmware, programmable circuitry, or any other processing device well known in the art. Similarly the logic may be embodied on software suitable to be executed by a processor, as is also well known in the art. The invention is not limited in this regard. The software, firmware, and/or processing device may be included, for example, on a downhole assembly in the form of a circuit board, on board a sensor sub, or MWD/LWD sub. Alternatively the processing system may be at the surface and configured to process data sent to the surface by sensor sets via a telemetry or data link system also well known in the art. Electronic information such as logic, software, or measured or processed data may be stored in memory (volatile or non-volatile), or on conventional electronic data storage devices such as are well known in the art.

Although the present invention and its advantages have been described in detail, it should be understood that various changes, substitutions and alternations can be made herein without departing from the spirit and scope of the invention as defined by the appended claims.

I claim:

1. A method for synchronizing a received waveform with respect to a transmitted waveform, the method comprising:
(a) receiving a waveform in a subterranean borehole;
(b) pre-processing the waveform received in (a) to obtain in-phase and out-of-phase digitized waveforms;
(c) processing the in-phase and out-of-phase digitized waveforms obtained in (b) to obtain at least one phase adjustment and a symbol clock adjustment;
(d) processing the phase adjustment and the symbol clock adjustment to obtain a decoded symbol sequence; and
(e) processing the decoded symbol sequence to obtain a frame boundary.

2. The method of claim 1, further comprising:
(f) processing the decoded symbol sequence and the frame boundary to decode at least one payload sequence.

3. The method of claim 1, wherein said processing in (c) yields a plurality of possible phase adjustments.

4. The method of claim 1, wherein said processing in (c) yields four possible phase adjustments θ₁, θ₂, θ₃, and θ₄ such that θ₄=θ₃+π/2=θ₂+π=θ₁+3π/2.

5. The method of claim 4, wherein said processing in (e) determines a single phase adjustment from the four possible phase adjustments θ₁, θ₂, θ₃, and θ₄ obtained in (c).

6. The method of claim 1, wherein (c) further comprises:
(i) processing the in-phase and out-of-phase digitized waveforms obtained in (b) in combination with one another to obtain a feedback signal; and
(ii) processing the feedback signal with a loop filter to obtain the phase adjustment.

7. The method of claim 1, wherein (c) further comprises:
(i) processing at least one of the in-phase and out-of-phase digitized waveforms obtained in (b) to obtain a feedback signal; and
(ii) processing the feedback signal with a loop filter to obtain the symbol clock adjustment.

8. The method of claim 1, wherein the decoded symbol sequence includes a plurality of frames and a repeating preamble sequence, each of the frames including the preamble sequence and a corresponding payload, the preamble sequence including a plurality of decoded symbols; and
(e) further comprises computing a correlation of the preamble sequence in the decoded symbol sequence received in (a) to obtain the frame boundary.

9. A method for synchronizing a received waveform with respect to a starting phase of a transmitted waveform, the method comprising:
(a) receiving a waveform in a subterranean borehole;
(b) pre-processing the waveform received in (a) to obtain in-phase and out-of-phase digitized waveforms;
(c) processing the in-phase and out-of-phase digitized waveforms obtained in (b) in combination with one another to obtain a feedback signal; and
(d) processing the feedback signal obtained in (c) with a loop filter to obtain a phase adjustment.

10. The method of claim 9, wherein the waveform received in (a) is a very low radio frequency waveform.

11. The method of claim 9, wherein (c) comprises:
(i) processing the in-phase and out-of-phase digitized waveforms obtained in (b) to obtain in-phase and out-of-phase decision statistics; and
(ii) processing the in-phase and out-of-phase decision statistics to obtain the feedback signal.

12. The method of claim 11, wherein the in-phase and out-of-phase decision statistics comprise demodulated sums over a predetermined period of the corresponding digitized in-phase and out-of-phase waveforms.

13. The method of claim 12, wherein:
the in-phase and out-of-phase decision statistics further comprise signs of the demodulated sums; and
the feedback signal is obtained by cross multiplying the in-phase and out-of-phase decision statistics.

14. The method of claim 9, wherein the feedback signal is computed according to the equation:
Ψ(t)=\hat{d}₂² ε_{I}+\hat{d}₁² ε_{Q}=2 sin φ
wherein Ψ(t) represents the feedback signal, \hat{d}₁ and \hat{d}₂ represent first and second input bits of an input symbol, ε_{I} and ε_{Q} represent the in-phase and out-of-phase digitized waveforms, and φ represents an estimated phase error between the received and transmitted waveforms.

15. The method of claim 9, wherein the loop filter is a proportional, proportional integral, or proportional integral differential controller.

16. The method of claim 9, further comprising:
(e) applying the phase adjustment obtained in (d) to the in-phase and out-of-phase digitized waveforms obtained in (b).

17. The method of claim 15, further comprising:
(f) repeating (c), (d), and (e).

18. A method for synchronizing a received waveform with respect to a symbol transition in a transmitted waveform, the method comprising:
(a) receiving a waveform in a subterranean borehole;
(b) pre-processing the waveform received in (a) to obtain in-phase and out-of-phase digitized waveforms;
(c) processing at least one of the in-phase and out-of-phase digitized waveforms obtained in (b) to obtain a feedback signal; and
(d) processing the feedback signal obtained in (c) with a loop filter to obtain a symbol clock adjustment.

19. The method of claim 18, wherein the waveform received in (a) is a very low radio frequency waveform.

20. The method of claim 18, wherein (c) comprises:
(i) processing the in-phase and out-of-phase digitized waveforms obtained in (b) to obtain in-phase and out-of-phase symbol statistics; and
(ii) processing at least one of the in-phase and out-of-phase symbol statistics to obtain the feedback signal.

21. The method of claim 20, wherein (c) comprises:
(i) computing a demodulated sum of a first portion of at least one of the in-phase and out-of-phase digitized waveforms obtained in (b);
(ii) computing a demodulated sum of a second portion of at least one of the in-phase and out-of-phase digitized waveforms obtained in (b); and
(iii) computing a difference between the demodulated sum of the second portion and the demodulated sum of the first portion to obtain the feedback signal.

22. The method of claim 18, wherein the symbol clock adjustment comprises an integer number of phase cycles.

23. The method of claim 18, wherein the loop filter is a proportional, proportional integral, or proportional integral differential controller.

24. The method of claim 18, further comprising:
(e) applying the symbol clock adjustment obtained in (d) to the in-phase and out-of-phase digitized waveforms obtained in (b).

25. The method of claim 24, further comprising:
(f) repeating (c), (d), and (e).

26. The method of claim 18, further comprising
(e) processing the symbol clock adjustment obtained in (d) in combination with the in-phase and out-of-phase digitized waveforms to decode at least one symbol.

27. A method for synchronizing a received symbol sequence with respect to a frame boundary in a transmitted waveform, the method comprising:
(a) receiving a decoded symbol sequence at a downhole processor, the symbol sequence including a plurality of frames and at least one repeating preamble sequence, each of the frames including a preamble sequence and a corresponding payload, each preamble sequence including a plurality of decoded symbols;
(b) computing a correlation of each preamble sequence in the decoded symbol sequence received in (a) to obtain a frame boundary; and
(c) processing the decoded symbol sequence received in (a) and the frame boundary obtained in (b) to decode the payload symbols.

28. The method of claim 27, wherein (b) comprises:
(i) correlating the decoded symbol sequence received in (a) for one or more occurrences of the preamble sequence to obtain a sequence of correlation indices;
(ii) accumulating the sequence of correlation indices to obtain accumulated indices;
(iii) searching the accumulated indices to located a largest accumulated index; and
(iv) assigning a frame boundary to said location of the largest accumulated index.

29. The method of claim 28, wherein each index in the sequence of correlation indices represents a number of matched symbols between the preamble sequence and a portion of the decoded symbol sequence.

30. The method of claim 28, wherein the sequence of correlated indices is accumulated in (ii) at an interval equal to a length of a single one of the frames.
